(19) United States
(12) Patent Application Publication
(10) Pub. No.: US 2024/0303727 A1
(43) Pub. Date: Sep. 12, 2024

(54) METHOD AND SYSTEM FOR AUTOMATIC CASHFLOW CATEGORIZATION OF BANK TRANSACTIONS

(71) Applicant: Panax Tech Ltd., Tel Aviv (IL)

(72) Inventor: Yosef Haim ITZKOVICH, Tel Mond (IL)

(73) Assignee: Panax Tech Ltd., Tel Aviv (IL)

(21) Appl. No.: 18/596,848

(22) Filed: Mar. 6, 2024

Related U.S. Application Data
(60) Provisional application No. 63/488,534, filed on Mar. 6, 2023.

(51) Int. Cl. G06Q 40/02

(52) U.S. Cl. CPC G06Q 40/02

(57) ABSTRACT

A system and method of automatic cashflow categorization of bank transactions are provided herein. The method may the following steps: collecting banking data and Enterprise Resource Planning (ERP) data associated with a plurality of users; training, by a computer processor, and based on the banking data and the ERP data associated with the plurality of users, a global model for mapping the banking data associated with the plurality of users into cashflow categories; and training, by the computer processor, and based on the global model and tagged dataset from a specific user of the plurality of user, a user-specific model for mapping the banking data associated with the specific users into cashflow categories associated with the specific user.

### CROSS REFERENCE TO RELATED APPLICATION

This application is a U.S. Non-Provisional Patent Application, claiming priority from U.S. Provisional Patent Application No. 63/488,534 filed Mar. 6, 2023, which is incorporated herein by reference in its entirety.

### FIELD OF THE INVENTION

The present invention relates generally to the field of data processing, and more particularly to automatic classification of financial data.

### BACKGROUND OF THE INVENTION

While online banking for business users provides accurate transactional data, it lacks linking the transactions to the cashflow classification of the business. Traditionally, accountants and finance persons go over bank transactions periodically and attempt to label or tag the bank transaction with additional data based on their knowledge of the cashflow of the specific business.

These tasks are very labor intense and require repetitive actions. In addition, the outcome does not provide the full picture of the cash utilization of the business and is less user-friendly for the non-finance persons of the business.

### SUMMARY OF THE INVENTION

In order to address the aforementioned challenges, some embodiments of the present invention improve basic technology and provide an automatic cashflow categorization of bank transactions.

According to embodiments of the present invention, a cash flow management platform for small and medium size enterprises to help businesses make data-driven decisions to support both daily and long-term growth decisions, solving a huge pain for finance teams.

The system and method in accordance with some embodiments of the present invention connects to various data sources to get 360 views on the company's Cash and liquidity.

The system and method in accordance with some embodiments of the present invention connects to banks via different methods such as API, API Aggregator, Host-2-Host, and more. In addition, the system and method in accordance with some embodiments of the present invention connects to ERPs (Enterprise Resource Planning systems) to get additional data in order to get the full picture. This includes accounts payments (AP) and accounts receivable (AR) and additional information such as a Chart of Accounts categories and Vendors per transaction.

Advantageously, the system and method in accordance with some embodiments of the present invention may provide a direct cash report, which enables users to analyze and understand cash movements in the company. This is done by a smart categorization process, which assigns a cash category to each transaction.

Further advantageously the system and method in accordance with some embodiments of the present invention may provide a unique visualization—to visualize inflow and outflow cashflow categorization during a time period.

It is the object of the embodiments of the present invention to enable finance teams to manage and control their cash flow by combining various data sources and adding a level of richness, which focuses on giving users insights on cash uses and sources.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram illustrating a system for automatic cashflow categorization of bank transactions in accordance with embodiments of the present invention;

FIG. 2 is a high-level flowchart illustrating a method of automatic cashflow categorization of bank transactions in accordance with some embodiments of the present invention;

FIG. 3 is a diagram illustrating a visualization of a data analysis in accordance with some embodiments of the present invention; and

FIG. 4 is a block diagram illustrating the architecture according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

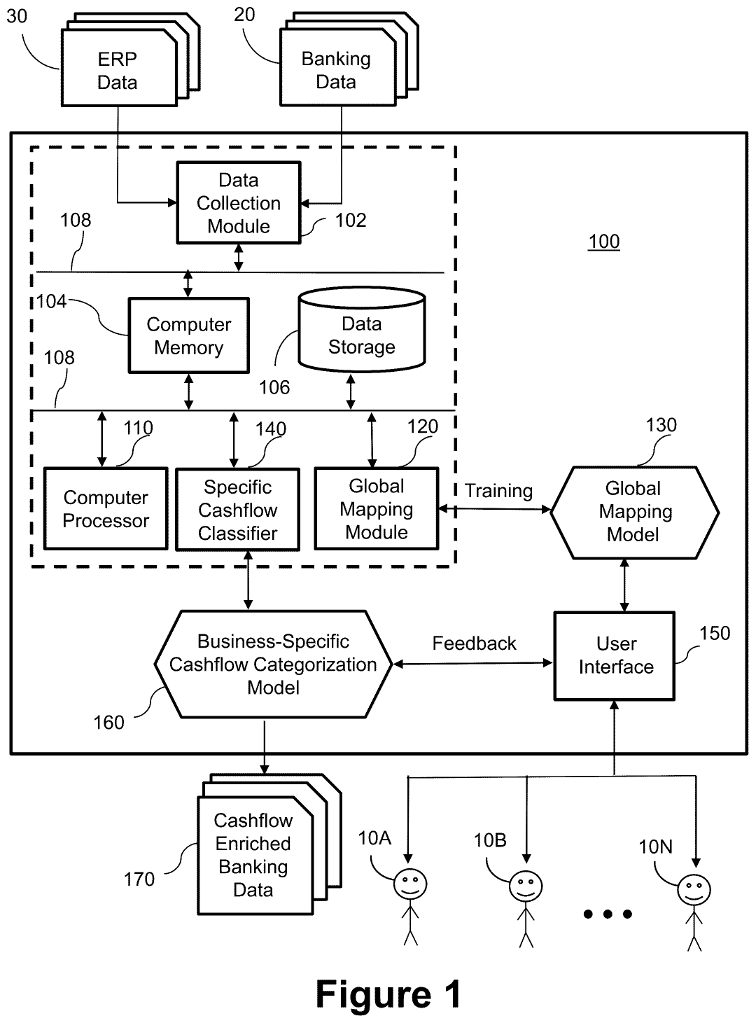

FIG. 1 is a high-level block diagram illustrating a system 100 for an automatic cashflow categorization of bank transactions. System 100 may include: a computer processor 110; a bus 108 connecting all modules, and computer memory 104 comprising a set of instructions that, when executed, cause computer processor 110 to: collect via a data collection module 102, banking data 20 and Enterprise Resource Planning (ERP) data 30 associated with a plurality of users 10A-10N and store them on a data storage 106.

Computer processor 110 may be further configured to train, using a global mapping module 120, and based on the banking data 20 and the ERP data 30 associated with the plurality of users 10A-10N, a global model 130 for mapping the banking data associated with the plurality of users into cashflow categories.

Computer processor 110 may be further configured to train, using a specific cashflow classifier 140, and based on the global model 130 and tagged dataset provided via a user interface 150 from a specific user 10N of the plurality of users, a user-specific model 160 for mapping the banking data associated with specific user 10N into cashflow categories associated with the specific user.

According to some embodiments of the present invention, each transaction contains an amount, currency, and some level of description. The ERP records are more detailed and contain each transaction's Vendor/Merchant name to which money will transfer from or to. It also contains a chart of accounts categorization, which is needed for various accounting reports and focuses on accrual basis recording but doesn't give an insightful view of cash movements.

In some embodiments of the present invention the user interface 150 is further configured to apply the user-specific model to banking data associated with the specific user for enriching the banking data with cashflow categories associated with the specific user 170.

In some embodiments of the present invention the user interface is further configured to create a visualization presenting the banking data associated with the specific user with the cashflow categories associated with the specific user.

In some embodiments of the present invention the training, the user-specific model is based on at least one of: Authorized date, Transaction date, Authorized day of the week, Transaction Day of the week, Amount, Description, and Vendor/Merchant name.

In some embodiments of the present invention, the ERP data comprises at least one of: accounts payable (AP) and accounts receivable (AR), Chart of Accounts (CoA) categories, and Vendors.

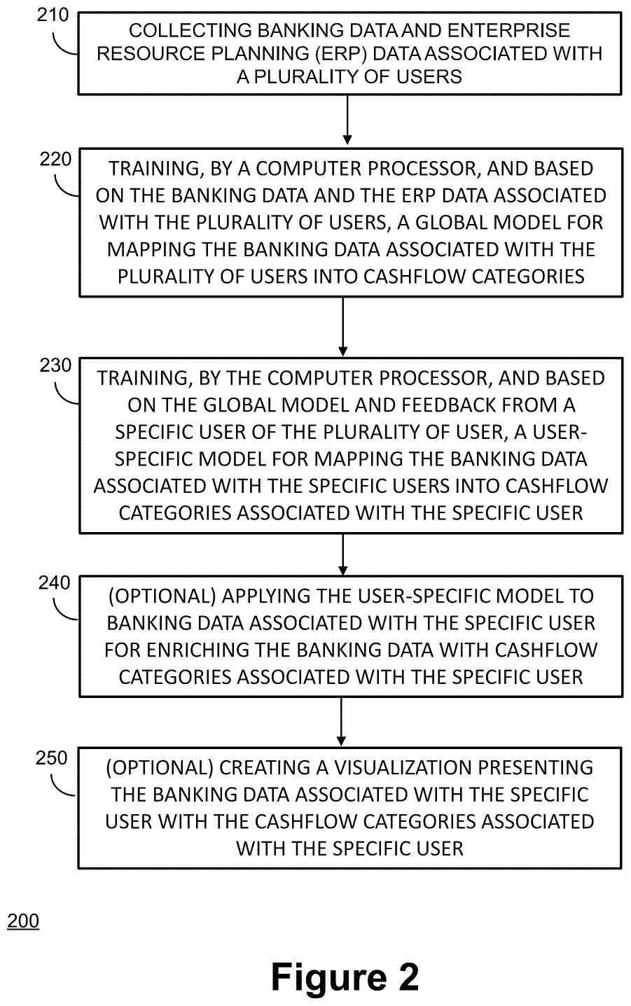

FIG. 2 is a high-level flowchart illustrating a method 200 of automatic cashflow categorization of bank transactions in accordance with some embodiments of the present invention. Method 200 may include the following steps: collecting banking data and Enterprise Resource Planning (ERP) data associated with a plurality of users 210; training, by a computer processor, and based on the banking data and the ERP data associated with the plurality of users, a global model for mapping the banking data associated with the plurality of users into cashflow categories 220; and training, by the computer processor, and based on the global model and tagged dataset from a specific user of the plurality of user, a user-specific model for mapping the banking data associated with the specific users into cashflow categories associated with the specific user 230.

In some embodiments of the present invention, method 200 may optionally include the step of applying the user-specific model to banking data associated with the specific user for enriching the banking data with cashflow categories associated with the specific user 240.

In some embodiments of the present invention, method 200 may optionally include the step of creating a visualization presenting the banking data associated with the specific user with the cashflow categories associated with the specific user 250.

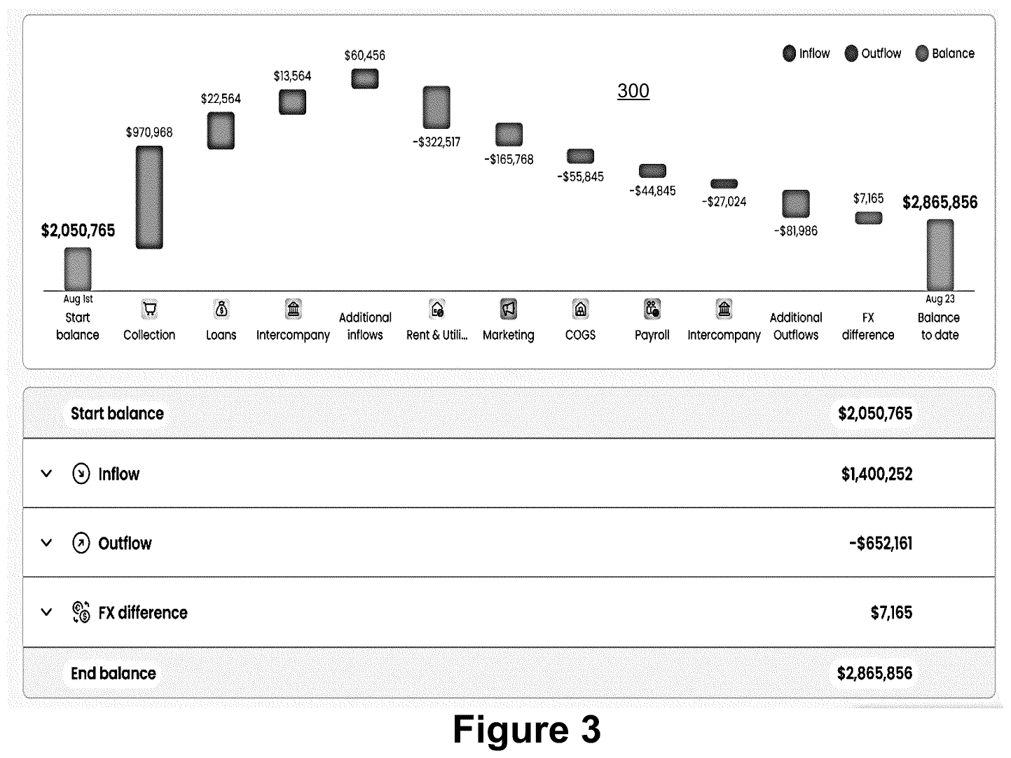

FIG. 3 is a diagram illustrating a visualization of a data analysis in accordance with some embodiments of the present invention. The visualization of the outcome analysis of embodiments of the present invention may include a chart 300 presenting to a user a so-called “Cashflow Bridge” which selectively presents the inflow the outflow and the balance of the banking data associated with a subset of the cashflow categories tailored per the user. In a non-limiting example, there can be in total 30 cashflow categories of a specific user/company. Since 30 cashflow categories may cause clutter in presenting the cashflow data, the number of cashflow categories may be reduced into, for example, 10 categories.

In some embodiments of the present invention, the reduction of number of cashflow categories may be carried out by applying the following reduction criteria:
a) A total amount of transactions (sum in $) of that category;
b) A number of transactions of that category;
c) A general importance of category (e.g., “collection”, “payroll”, etc.); and
d) A user-specific preference (e.g., “bank fees”).

In some embodiments of the present invention, a further machine learning model may be used for ranking the reduced categories to be presented on the visualization.

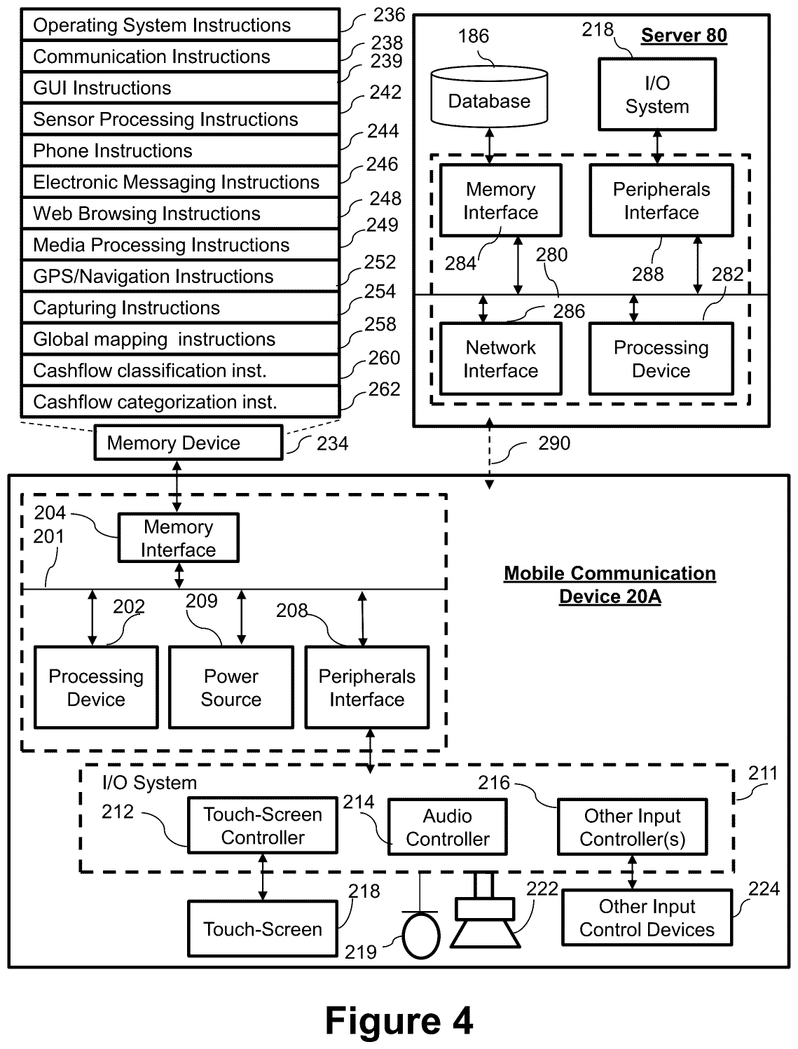

FIG. 4 shows a block diagram of the configuration of a mobile communication device 20A and server 80 to serve as cashflow categorization of bank transactions tool. With regard to the mobile communication device 20A, and according to some embodiments, the mobile communication device 20A, directly or indirectly, may access a bus 200 (or another data transfer mechanism) that interconnects subsystems and components for transferring information within the mobile communication device 20A. For example, bus 200 may interconnect a processing device 202, a memory interface 204, and a peripherals interface 208 connected to an I/O system 210. Power source 209 provides the power to the mobile communication device and it may include a primary or a rechargeable battery (not shown), DC-DC converters (not shown) and other components required for the proper operation mobile communication device 20A.

In some embodiments, processing device 202 may use a memory interface 204 to access data and a software product stored on a memory device 234 or a non-transitory computer-readable medium device 234.

According to some embodiments, the peripherals interface 208 may also be connected to sensors, devices, and subsystems to facilitate multiple functionalities. In one embodiment, the peripherals interface 208 may be connected to an I/O system 210 configured to receive signals or input from devices and to provide signals or output to one or more devices that allow data to be received and/or transmitted by the mobile communication device 20. In one example, the I/O system 210 may include a touch screen controller 212, audio controller 214, and/or other types of input controller(s) 216. The touch screen controller 212 may be coupled to a touch screen 218. The touch screen 218 and the touch screen controller 212 may, for example, detect contact, and movement, using any of a plurality of touch sensitivity technologies, including but not limited to capacitive, resistive, infrared, and surface acoustic wave technologies as well as other proximity sensor arrays or other elements for determining one or more points of contact with the touch screen 218. The touch screen 218 may also, for example, be used to implement virtual or soft buttons and/or a keyboard. While a touch screen 218 is shown in FIG. 4, I/O system 210 may include a display screen (e.g., LCD or LED) in place of a touch screen 218.

Consistent with the present disclosure, the mobile communication device 20A may use a memory interface 204 to access a memory device 234. The memory device 234 may store an operating system 236, such as Android, IOS, MS Windows, Linux, or any other embedded operating system. Operating system 236 may include instructions for handling basic system services and for performing hardware-dependent tasks. In some implementations, the operating system 236 may be a kernel (e.g., Linux kernel).

The memory device 234 may also store communication instructions 238 to facilitate communicating with one or more additional devices, one or more computers, and/or one or more servers. The memory device 234 may include: graphical user interface instructions 240 to facilitate graphic user interface processing; sensor processing instructions 242 to facilitate sensor-related processing and functions; phone instructions 244 to facilitate phone-related processes and functions; electronic messaging instructions 246 to facilitate electronic-messaging-related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226.

Each of the above-identified instructions and applications may correspond to a set of instructions for performing one or more functions described above. These instructions do not necessarily need to be implemented as separate software programs, procedures, or modules. The memory device 234 may include additional instructions or fewer instructions. Furthermore, various functions of the mobile communication device 20A may be implemented in hardware and/or software, including in one or more signal processing and/or application-specific integrated circuits.

Still referring to FIG. 4, and according to some embodiments of the present invention, a server 80 for cashflow categorization of bank transactions accessed and presented by at least one mobile communication device 20A.

Processing device 282 may include at least one processor configured to execute computer programs, applications, methods, processes, or other software to perform embodiments described in the present disclosure.

In some embodiments, processing device 282 may use a memory interface 284 to access data and a software product stored on a memory device or a non-transitory computer-readable medium or to access a database 186.

According to some embodiments, the network interface 286 may provide two-way data communication to a network. In FIG. 1, communication 290 between mobile communication device 20A and server 80 is represented by a dashed arrow. In one embodiment, the network interface 286 may include an integrated services digital network (ISDN) card, cellular modem, satellite modem, or a modem to provide a data communication connection over the Internet. As another example, the network interface 286 may include a wireless local area network (WLAN) card. In another embodiment, the network interface 286 may include an Ethernet port connected to radio frequency receivers and transmitters. The specific design and implementation of the network interface 286 may depend on the communications network(s) over which the mobile communication device 20A and the server 80 may communicate.

According to some embodiments, the server 80 may also include a peripherals interface 288 coupled to the bus 280. The peripherals interface 288 may also be connected to devices, and subsystems to facilitate multiple functionalities as performed by the server 80. In some embodiments, those devices and subsystems may comprise a display screen (e.g., LCD) a USB port, and the like.

The components and arrangements shown in FIG. 4 for both server 80 and the mobile communication device 20A are not intended to limit the disclosed embodiments. As will be appreciated by a person skilled in the art having the benefit of this disclosure, numerous variations and/or modifications may be made to the depicted configuration of server 80 and the mobile communication device 20A. For example, not all the depicted components may be essential for the operation of server 80 or the mobile communication device 20A in all cases. Any component may be located in any appropriate part of server 80, and the components may be rearranged into a variety of configurations while providing the functionality of the disclosed embodiments.

According to some embodiments of the present invention, database 186 is configured to hold banking data and Enterprise Resource Planning (ERP) data associated with a plurality of users, which has been collected via a plurality of mobile communication devices such as mobile communication device 20A.

According to some embodiments of the present invention, memory device 234 may further include global mapping instructions 258 which cause processing device 202, when executed, to train, based on the banking data and the ERP data associated with the plurality of users, a global model for mapping the banking data associated with the plurality of users into cashflow categories.

Memory device 234 may further include cashflow classification instructions 260 which cause processing device 202, when executed, to train, based on the global model and tagged dataset from a specific user of the plurality of user, a user-specific model for mapping the banking data associated with the specific users into cashflow categories associated with the specific user.

Memory device 234 may further include cashflow categorization instructions 262 which cause processing device 202, when executed to apply the user-specific model to banking data associated with the specific user for enriching the banking data with cashflow categories associated with the specific user.

Memory device 234 may further include graphical user interface (GUI) instructions 239 which cause processing device 202, when executed to cause the at least one computer processor to create a visualization over touch screen 218 presenting the banking data associated with the specific user with the cashflow categories associated with the specific user.

It is further understood that some embodiments of the present invention may be embodied in the form of a system, a method, or a computer program product. Similarly, some embodiments may be embodied as hardware, software, or a combination of both. Some embodiments may be embodied as a computer program product saved on one or more non-transitory computer-readable medium (or mediums) in the form of computer-readable program code embodied thereon. Such non-transitory computer-readable medium may include instructions that when executed cause a processor to execute method steps in accordance with embodiments. In some embodiments, the instructions stored on the computer-readable medium may be in the form of an installed application and in the form of an installation package.

Such instructions may be, for example, loaded by one or more processors and get executed. For example, the computer-readable medium may be a non-transitory computer-readable storage medium. A non-transitory computer-readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

1. A method of automatic cashflow categorization of bank transactions, the method comprising:
collecting banking data and Enterprise Resource Planning (ERP) data associated with a plurality of users;
training, by a computer processor, and based on the banking data and the ERP data associated with the plurality of users, a global model for mapping the banking data associated with the plurality of users into cashflow categories; and
training, by the computer processor, and based on the global model and tagged dataset from a specific user of the plurality of user, a user-specific model for mapping the banking data associated with the specific users into cashflow categories associated with the specific user.

2. The method according to claim 1, further comprising applying the user-specific model to banking data associated with the specific user for enriching the banking data with cashflow categories associated with the specific user.

3. The method according to claim 2, further comprising creating a visualization presenting the banking data associated with the specific user with the cashflow categories associated with the specific user.

4. The method according to claim 1, wherein the training, the user-specific model is based on at least one of: Authorized date, Transaction date, Authorized day of a week, Transaction Day of the week, Amount, Description, and Vendor/Merchant name.

5. The method according to claim 1, wherein the ERP data comprises at least one of: accounts payable (AP) and accounts receivable (AR), Chart of Accounts (CoA) categories, and Vendors.

6. The method according to claim 3, wherein the visualization comprises a reduced number of cashflow categories associated with the specific user, wherein the reduced number of cashflow categories is selected based on a specific user.

7. The method according to claim 3, wherein the visualization comprises a reduced number of cashflow categories associated with the specific user, wherein the reduced number of cashflow categories is selected based on a machine learning model generated for a specific user.

8. A system of automatic cashflow categorization of bank transactions, the system comprising:
a computer processor;
computer memory comprising a set of instructions that, when executed, cause at least one computer processor to:
collect via a data collection module, banking data and Enterprise Resource Planning (ERP) data associated with a plurality of users;
train, using a global mapping module, and based on the banking data and the ERP data associated with the plurality of users, a global model for mapping the banking data associated with the plurality of users into cashflow categories;
train, using a specific cashflow classifier, and based on the global model and tagged dataset provided via a user interface from a specific user of the plurality of user, a user-specific model for mapping the banking data associated with the specific users into cashflow categories associated with the specific user.

9. The system according to claim 8, wherein the user interface is further configured to apply the user-specific model to banking data associated with the specific user for enriching the banking data with cashflow categories associated with the specific user.

10. The system according to claim 8, wherein the user interface is further configured to create a visualization presenting the banking data associated with the specific user with the cashflow categories associated with the specific user.

11. The system according to claim 8, wherein the training, the user-specific model is based on at least one of: Authorized date, Transaction date, Authorized day of a week, Transaction Day of the week, Amount, Description, and Vendor/Merchant name.

12. The system according to claim 8, wherein the ERP data comprises at least one of: accounts payable (AP) and accounts receivable (AR), Chart of Accounts (CoA) categories, and Vendors.

13. The system according to claim 10, wherein the visualization comprises a reduced number of cashflow categories associated with the specific user, wherein the reduced number of cashflow categories is selected based on a specific user.

14. The system according to claim 10, wherein the visualization comprises a reduced number of cashflow categories associated with the specific user, wherein the reduced number of cashflow categories is selected based on a machine learning model generated for a specific user.

15. A non-transitory computer readable medium for automatic cashflow categorization of bank transactions, the computer readable medium comprising a set of instructions that, when executed, cause at least one computer processor to:
collect banking data and Enterprise Resource Planning (ERP) data associated with a plurality of users;
train, by a computer processor, and based on the banking data and the ERP data associated with the plurality of users, a global model for mapping the banking data associated with the plurality of users into cashflow categories; and
train, by the computer processor, and based on the global model and tagged dataset from a specific user of the plurality of user, a user-specific model for mapping the banking data associated with the specific users into cashflow categories associated with the specific user.

16. The non-transitory computer readable medium according to claim 15, the computer readable medium further comprises instructions that, when executed, cause the at least one computer processor to apply the user-specific model to banking data associated with the specific user for enriching the banking data with cashflow categories associated with the specific user.

17. The non-transitory computer readable medium according to claim 15, the computer readable medium further comprises instructions that, when executed, cause the at least one computer processor to create a visualization presenting the banking data associated with the specific user with the cashflow categories associated with the specific user.

18. The non-transitory computer readable medium according to claim 15, wherein the training of the user-specific model is based on at least one of: Authorized date, Transaction date, Authorized day of a week, Transaction Day of the week, Amount, Description, and Vendor/Merchant name.

19. The non-transitory computer readable medium according to claim 15, wherein the ERP data comprises at least one of: accounts payable (AP) and accounts receivable (AR), Chart of Accounts (CoA) categories, and Vendors.

20. The non-transitory computer readable medium according to claim 17, wherein the visualization comprises a reduced number of cashflow categories associated with the specific user, wherein the reduced number of cashflow categories is selected based on a specific user.
